(19) United States
(12) Patent Application Publication
(10) Pub. No.: US 2022/0237627 A1
(43) Pub. Date: Jul. 28, 2022

(54) DIGITAL MARIJUANA FACILITY REMOTE ASSESSMENT, INSPECTION, AND REPORTING PLATFORM

(71) Applicant: Reginald S. Jones, SR., Naperville, IL (US)

(72) Inventor: Reginald S. Jones, SR., Naperville, IL (US)

(21) Appl. No.: 17/584,381

(22) Filed: Jan. 26, 2022

Related U.S. Application Data
(60) Provisional application No. 63/141,583, filed on Jan. 26, 2021.

(51) Int. Cl. G06Q 30/00

(52) U.S. Cl. CPC G06Q 30/018

(57) ABSTRACT

Techniques are described herein for providing a system and techniques for enabling remote monitoring, assessing, inspecting of a marijuana dispensary facility through remote reporting provided by an operator of the facility. A platform server generates a questionnaire prompt in response to a request to initiate an assessment of a marijuana dispensary facility of an operator user. The platform server presents, via a user interface, the questionnaire prompt and receives submission data from the operator user in response The platform server generates an assessment report from the submission data. The platform server presents the assessment report to an assessor user and receives an indication from the assessor user of whether to approve or reject the assessment report and/or request further information germane to the report or supplementation of the report.

### CROSS-REFERENCE TO RELATED APPLICATIONS

This application claims priority to U.S. Provisional Patent Application No. 63/141,583, filed Jan. 26, 2021.

### FIELD

The present disclosure generally relates to a system and techniques for providing a bi-directional platform for remotely monitoring, assessing and inspecting a marijuana dispensary and then generating the necessary reporting of the dispensary's operations to comply with the relevant laws and regulations.

### BACKGROUND

The medical and recreational marijuana industry is rapidly expanding across a number of states. Generally, an entity must undergo a stringent, multi-step, in-person inspection process to be licensed by a given state to dispense marijuana. The inspection process may involve a detailed review of the entity's dispensary facility, which includes logistics and processes associated with the facility as well as the security of the facility. For example, Title 68 of the Illinois Administrative Code provides detailed requirements to which the entity's facility must adhere for authorization by the state of Illinois. An assessor, often employed by the state or a third-party, conducts the inspection in-person at the facility to ensure that the facility adheres to the requirements and issues an approval based on the inspection. The inspection process is typically paper intensive and lengthy on both the part of the entity and the assessor.

Circumstances have demonstrated the drawbacks of requiring an assessor to conduct an in-person inspection of a marijuana dispensary facility. For instance, the novel coronavirus (COVID-19) pandemic has created risks to both the assessor and facility operator being in close proximity to one another. In addition, the amount of paperwork required for each inspection is considerable and increases the risk for human error. Consequently, the current approach to monitoring, assessing and inspecting marijuana dispensary facilities presents numerous challenges and shortcomings.

The description provided in the Background section should not be assumed to be prior art merely because it is mentioned in or associated with the Background section.

### SUMMARY

Embodiments presented herein disclose a system and techniques for providing a bi-directional platform for monitoring, assessing and inspecting a marijuana dispensary in an efficient and timely manner.

For example, embodiments presented herein disclose a computer-implemented method. The method generally discloses generating, by execution of one or more processors and in response to a request to initiate an assessment of a marijuana dispensary facility of an operator user, a questionnaire prompt. The questionnaire prompt maps regulations pertaining to marijuana dispensary authorization within a given state to a plurality of questions and requests for submissions. The questionnaire prompt is presented via a user interface. The method also generally includes receiving, in response to the presentation of the questionnaire prompt, submission data from the operator user. An assessment report is generated from the submission data.

### BRIEF DESCRIPTION OF THE DRAWINGS

FIG. 1 illustrates an exemplary computing environment providing a platform for enabling remote assessment, inspection and reporting of a marijuana dispensary facility, according to an embodiment;

FIG. 2 is a block diagram of the platform server described relative to FIG. 1, according to an embodiment;

FIG. 3 is a block diagram of a client device used to communicate with the platform server described relative to FIG. 1, according to an embodiment;

FIG. 4 is a flow diagram of an exemplary method for conducting an assessment of a marijuana dispensary facility by the platform server described relative to FIG. 1, according to an embodiment;

FIG. 5 is a flow diagram of an example method for further conducting an assessment of a marijuana dispensary facility by the platform server described relative to FIG. 1, according to an embodiment; and

FIGS. 6A and 6B illustrate exemplary conceptual diagrams of a user interface generated by the platform server described relative to FIG. 1.

### DETAILED DESCRIPTION

Embodiments presented herein disclose a system and techniques for enabling remote monitoring, assessing, inspecting of a marijuana dispensary facility through remote reporting provided by an operator of the facility. More specifically, embodiments provide a software platform accessible by an operator of the dispensary facility user and an assessor user. The platform generates a prompt including a questionnaire tailored to regulations provided by marijuana dispensary laws and regulations within a given state or municipality. For example, Title 68 of the Illinois Administrative Code specifies licensing requirements for operating a marijuana dispensary facility in the state of Illinois, with subjects ranging from safety to security of the dispensary. An assessor, e.g., an employee licensed by the state, uses these state-mandated requirements as a basis for assessing and inspecting the dispensary facility to assess compliance with the relevant laws and regulations. The questionnaire provided by the server prompts a dispensary operator (such as the owner, manager or employee of the dispensary) to respond to questions by submitting a combination of plain text and multimedia (e.g., documentation, photo media, video media, etc.) responses. Once submitted, the platform may generate an assessment report including the operator-submitted responses to the questions, which an assessor may evaluate and either approve or reject the report, subject to additional in-person inspection measures.

Advantageously, techniques described herein focus on intricacies of the marijuana dispensary facility process according to a state's laws and regulations to further create efficiency for an assessor, an applicant (e.g., an operator of the marijuana dispensary facility), and the underlying system architecture alike in the process. Further, these techniques include a specific set of system features and rules that provide an improved technological result for automatically managing the intake and collection of dispensary submission data for the purposes of assessing a marijuana dispensary facility. By collecting and storing dispensary submission data according to the techniques described herein, this approach improves data transfer rate (e.g., during retrieval of questionnaire data, submission of responses and multimedia) and also reduces the amount of paperwork typically necessary for monitoring and assessing the dispensary in view of the governing rules and regulations. Further, this approach includes an ordered combination of non-conventional pieces that form specific and practical applications for minimizing the amount of time required by the assessor to inspect or assess the facility in-person. Particularly, the questionnaire generated by the platform can be tailored to direct the dispensary operator to submit multimedia (e.g., photo and video data) to supplement in-person aspects associated with the assessment process. The platform also provides an improved user interface for computing devices that are particularly structured to present applicable information (e.g., the questionnaires, answer prompts, etc.) to assessors and operators in a reasonably easy-to-follow and time-efficient manner. Consequently, the techniques described herein address long existing problems associated with the conventional assessment process, including inefficient data collection, disorganization created by large amounts of paperwork, and the time to process the application.

The following detailed description includes references to the accompanying figures. In the figures, similar symbols typically identify similar components, unless context dictates otherwise. The exemplary embodiments described herein are not meant to be limiting. Other embodiments may be used, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

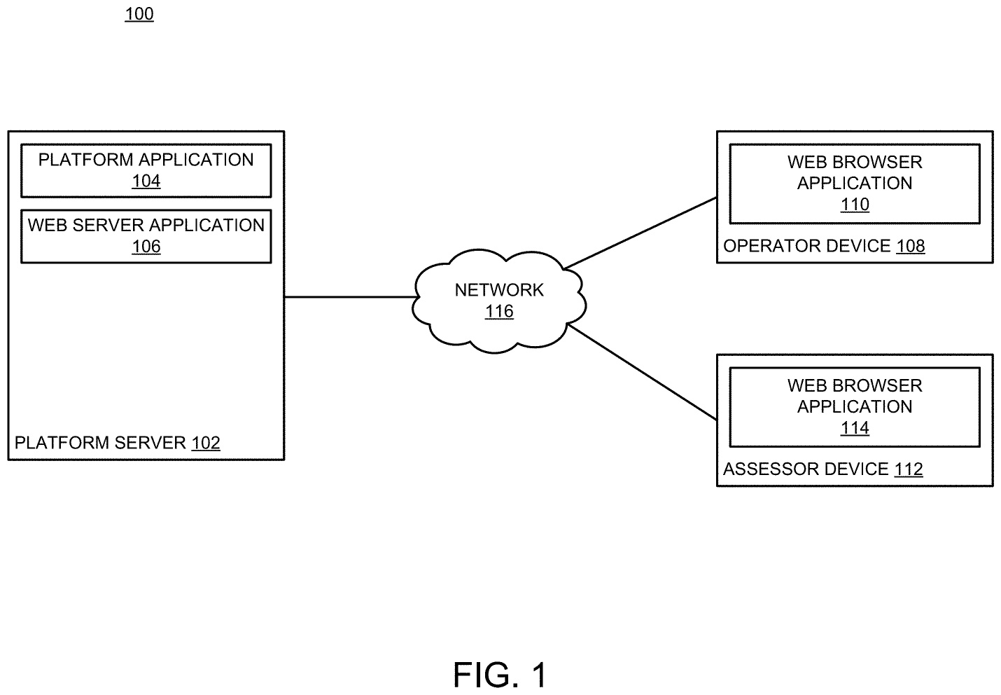

FIG. 1 illustrates an exemplary computing environment 100 in which remote assessment, inspection and reporting of a marijuana dispensary facility for state licensing purposes can be performed. As shown, the computing environment 100 includes a platform server 102, at least one dispensary operator device 108, and at least one assessor device 112, each connected to a network 116 (e.g., the Internet). Each of the platform server 102, operator device 108, and the assessor device 112 may be embodied as a physical hardware device (e.g., a desktop computer, laptop computer, smart tablet, smartphone, workstation, wearable, etc.) or a virtual instance executing on a cloud network.

In an embodiment, the platform server 102 provides a software-based platform for collecting data for monitoring, assessing and inspecting a marijuana dispensary facility from an operator using the operator device 108 (e.g., via a web browser application 110) and reporting the same to an assessor operating the assessor device 112 (e.g., via a web browser application 114) for approval or rejection. Each of the operator and the assessor may have a distinct set of user credentials to access the platform server 102 via the respective web browser application 110 or 114. Once logged in, the platform application 104 may present a user interface configured based on role (e.g., whether the user is an operator or an assessor). Although presented as a single computing system hosting the platform application 104 and the web server application 106, each of these components may reside on separate systems that can interface. Further, in some embodiments, the platform application 104 may be embodied as a standalone application executing on one of the operator device 108 or the assessor device 112, such as a desktop application or mobile application that interfaces with the platform server 102.

In some embodiments, components of the software platform, such as the platform server 102, may be embodied as a cloud-based platform (e.g., a software-as-a-service (SaaS) platform) executing over a cloud network. In addition, platform data (e.g., user data, questionnaire data, submission data, report data, etc.) maybe be hosted by one or more cloud storage services to allow for a secure and relatively efficient means of data management. Processing tasks by the software platform can be conducted on the cloud rather than by local systems to ensure efficiency.

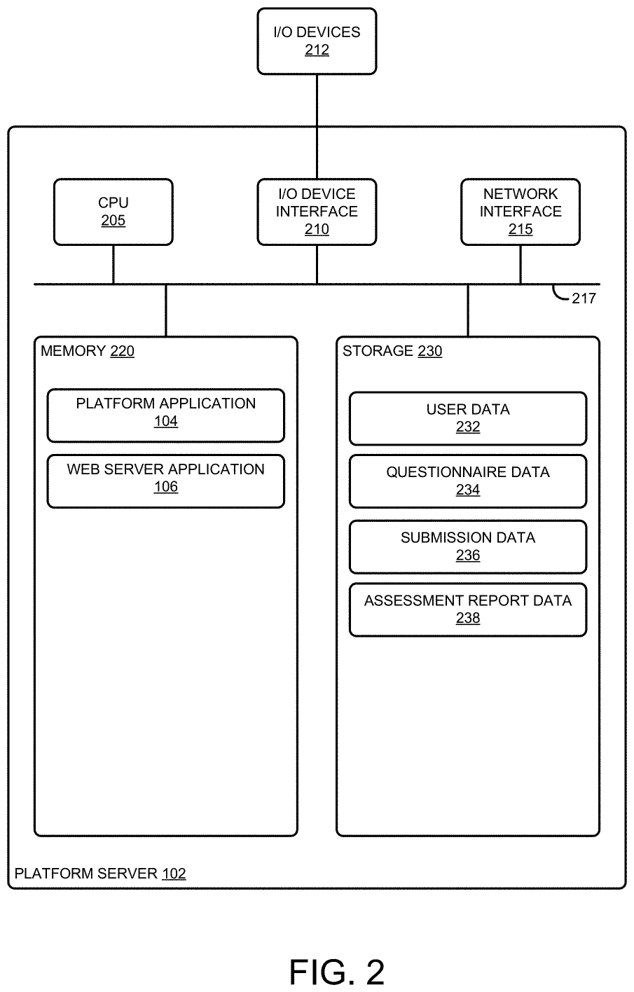

FIG. 2 further illustrates the platform server 102, according to an exemplary embodiment. As shown, the platform server 102 includes, without limitation, a central processing unit (CPU) 205, an I/O device interface 210, one or more I/O devices 212, and a network interface 215, each interconnected via a hardware bus 217. Of course, an actual platform server 102 can include a variety of additional hardware components, such as graphics processing units and cooling fans.

The CPU 205 retrieves and executes programming instructions stored in the memory 220 (e.g., of the platform application 104). Similarly, the CPU 205 stores and retrieves data residing in the storage 230. The hardware bus 217 is used to transmit instructions and data between the CPU 205, storage 230, network interface 215, and the memory 220. CPU 205 is included to be representative of a single CPU, multiple CPUs, a single CPU having multiple processing cores, and the like. The memory 220 is generally included to be representative of memory and storage on a mobile device, e.g., DDR and flash memory spaces. The network interface 215 may be embodied as any hardware, software, or circuitry (e.g., a network interface card) used to connect the platform server 102 over a network and providing the network communication component functions described above.

The I/O device interface 210 allows the I/O devices 212 to communicate with hardware and software components of the platform server 102. The I/O devices 212 may be embodied as any type of input/output device connected with or provided as a component to the platform server 102, such as the HD cameras, the speaker and/or the microphone devices described above. I/O devices such as scanners, keyboards, mice, and printers may be included as I/O devices 212 (e.g., to print an assessment report or enter submission data in response to a questionnaire prompt).

Illustratively, the memory 220 includes the platform application 104 and the web server application 106, which carries out functions described herein relative to FIG. 1. The platform application 104 may provide an API for external applications to use in communicating with the software platform (e.g., for facilitating retrieval and storage of assessment application data). The storage 230 includes user data 232, questionnaire data 234, submission data 236, and assessment report data 238. The user data 232 may be embodied as any data identifying information associated with a given operator user or assessor user. For example, in the case of an operator user, the user data 232 may include username information, password information, personal information (e.g., name and address of individual preparing assessment application), information regarding an underlying marijuana dispensary facility, contact information, and the like. In the case of an assessor user, the user data 232 may include username information, password information, personal information (e.g., name and address), employee identification information, contact information, and the like. Each user may be associated with a user identifier uniquely identifying the specific user(s) in the platform. The questionnaire data 234 may be embodied as any data or data set modeled after state and/or municipal laws and/or regulations to elicit information from an operator pursuant to complying with the state regulations. For example, the questionnaire data 234 may include requests for information regarding security measures undertaken at the dispensary facility, floor plans of the facility, security of the facility, monitoring at the facility, and the like. The questionnaire data 234 may also include prompts for text submission and submission of multimedia such as documents, photos, videos, and so on. The submission data 234 may be embodied as any data provided by a given user in response to receiving the questionnaire data 234 and submitted through the user interface. The submission data may include plain text data, multimedia data (e.g., documents, photos, videos, etc.), and the like. The assessment report data 238 may be embodied as any data representative of a report provided to an assessor in reviewing for approval. The assessment report data 238 may be generated from the submission data 234.

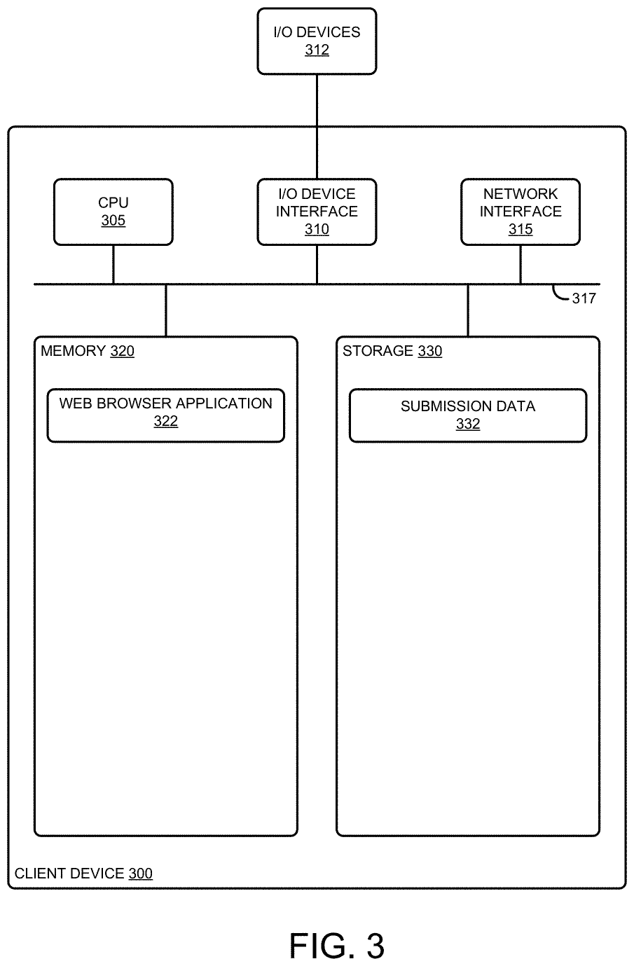

FIG. 3 illustrates a client device 300, according to an exemplary embodiment. The client device 300 may represent the operator device 108 or the assessor device 112 described relative to FIG. 1. As shown, the client device 300 includes, without limitation, a central CPU 305, an I/O device interface 310, one or more I/O devices 312, and a network interface 315, each interconnected via a hardware bus 317. Of course, a client device 300 will include a variety of additional hardware components.

The CPU 305 retrieves and executes programming instructions stored in the memory 320 (e.g., of the web browser application 322). Similarly, the CPU 305 stores and retrieves data residing in the storage 330, such as submission data 332. The hardware bus 317 is used to transmit instructions and data between the CPU 305, storage 330, network interface 315, and the memory 320. CPU 305 is included to be representative of a single CPU, multiple CPUs, a single CPU having multiple processing cores, and the like. The memory 320 is generally included to be representative of memory and storage on a mobile device, e.g., DDR and flash memory spaces. The network interface 315 may be embodied as any hardware, software, or circuitry (e.g., a network interface card) used to connect the client device 300 over a network and providing the network communication component functions described above.

The I/O device interface 310 allows the I/O devices 312 to communicate with hardware and software components of the client device 300. The I/O devices 312 may be embodied as any type of input/output device connected with or provided as a component to the client device 300, such as scanners, keyboards, mice, and printers may be included as I/O devices 212 (e.g., to print an assessment report or enter submission data 332).

Illustratively, the memory 320 includes a web browser application 322 used to access the platform application 104 through a web-based user interface provided by the web server application 106. Further, the storage 330 includes submission data 332, which includes plain text data, multimedia data (e.g., documents, photos, videos, etc.), and the like, responsive to questionnaire prompts by the platform application 104.

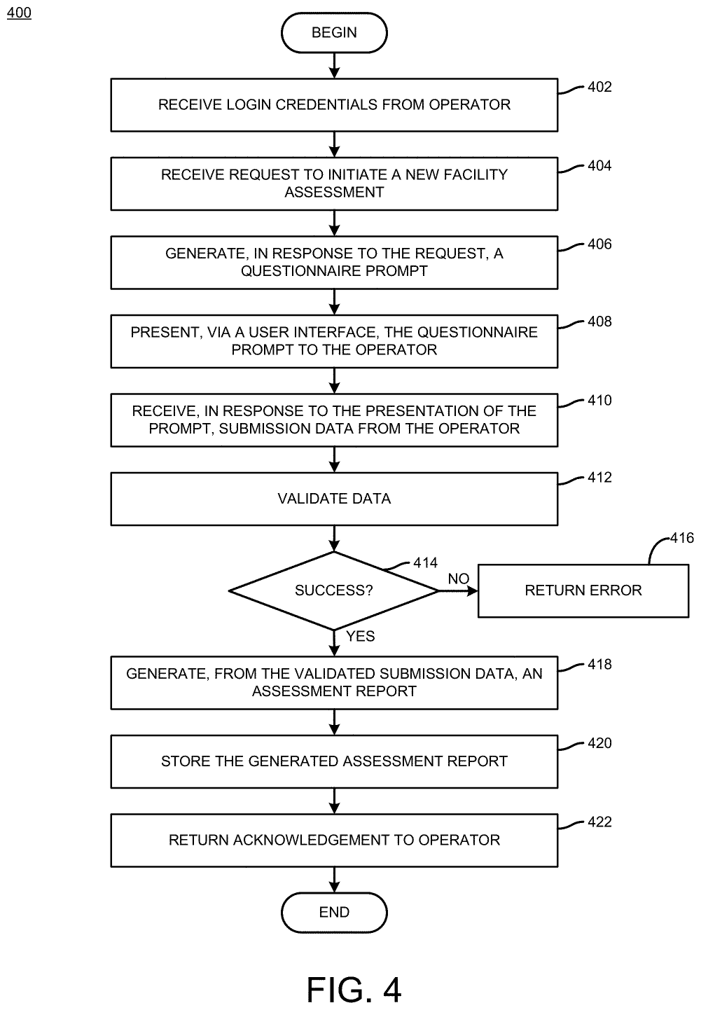

FIG. 4 illustrates a method 400 for conducting an assessment and/or inspection of a marijuana dispensary facility from the perspective of an operator user, according to an embodiment. As shown, the method 400 begins in block 402, in which the platform application 104 receives login credentials from the operator user. The login credentials may be transmitted by the operator device 108 via a web-based user interface (e.g., displayed on the web browser application 110). The login credentials may include a username and password for the operator user registered on the platform server 102. In some embodiments, to provide an additional layer of security, the platform application 104 may request additional credentials from the operator user (e.g., using a two-factor authentication method, requesting an employee ID, etc.).

In block 404, the platform application 104 may receive a request from the operator user to initiate a new remote assessment or inspection of the dispensary facility. The request may be transmitted via the web-based interface. In block 406, the platform application 104 may, in response to the request, generate a questionnaire prompt to which the operator user must submit responses. The questionnaire prompt maps regulations pertaining to marijuana dispensary authorization within a given state or municipality to a series of questions and prompts for submissions of multimedia (e.g., photo or video documents to be evaluated in the assessment). The generation of the questionnaire prompt may be based on retrieving a file of pre-defined questions. In other embodiments, the generation of the questionnaire prompt can be performed by obtaining current regulations from a given source (e.g., a website maintained by the state providing such regulations) and automatically generating the questionnaire using natural language processing (NLP) techniques in combination with one or more rules (e.g., mapping rules) for question generation. In such an approach, generation may occur over cloud resources to preserve local resources and allow for more efficient processing. In block 408, the platform application 104 presents, via the web-based user interface, the questionnaire prompts to the operator user.

In block 410, the platform application 104 receives submission data in response to the presentation of the prompt and from the operator user. The submission data may include plain text data, multimedia data (e.g., documents, photos, videos, etc.), and the like. In block 412, the platform application 104 may validate the submission data to ensure that the data requested from the prompt is in a proper format as well as legitimate. For example, the platform application 104 may evaluate geolocation metadata of a photo or video submitted by the operator user and compare the ascertained geolocation with an actual geolocation of the underlying marijuana facility. Doing so ensures that the photo or video submitted by the operator user (or the facility's authorized staff) was actually taken at the facility.

In block 414, the platform application 104 determines whether the validation is successful. If not, then in block 416, the platform application 104 may return an error to be displayed to the operator user. Otherwise, in block 418, the platform application 104 generates, from the validated submission data, an assessment report displaying the submitted data in a readable format. In an embodiment, the generation may be configured to better assist an assessor in evaluating the facility. For example, during the generation step, the platform application 104 may evaluate video and photo data using machine learning models to identify specific objects within the data that might satisfy a given regulation or trigger some flag for the assessor to focus on. For example, the platform application 104 may identify trees, bushes, and other foliage outside of windows displayed in a given photo and also determine a distance between one another. The platform application 104 may then determine whether such a distance would allow for an individual to conceal himself from sight, in violation of a given state regulation. In such a case, the platform application 104 may flag this issue in the assessment report.

Further, the platform application 104 may assign an identifier to the report (e.g., by an identifier associated with the application). In block 420, the platform application 104 may store the generated assessment report by identifier. In block 422, the platform application 104 may return an acknowledgement to the operator user confirming that the assessment report was generated, stored, and ready for review by an assessor.

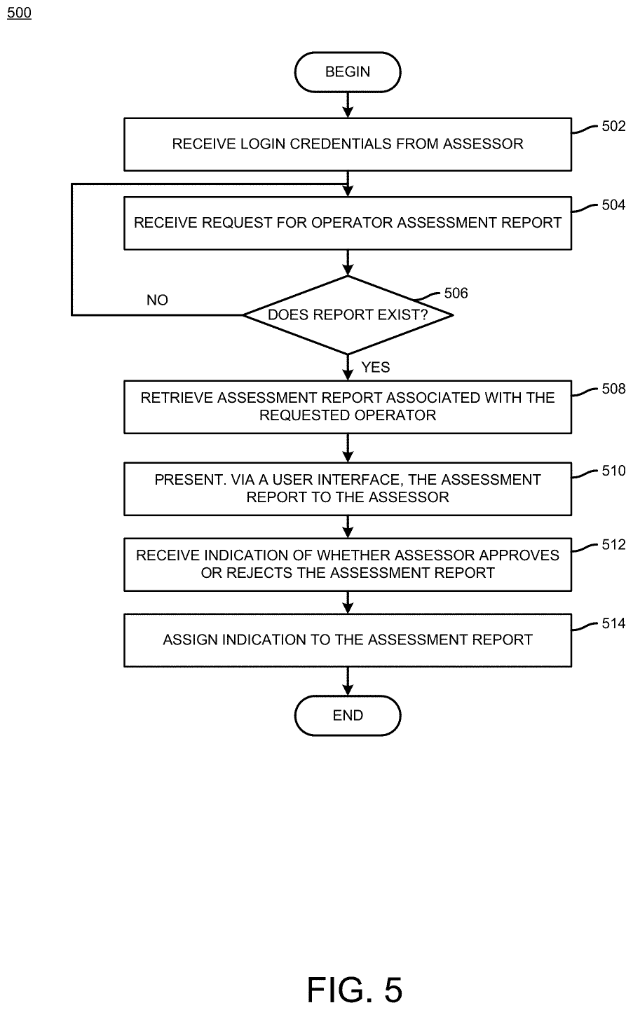

FIG. 5 illustrates a method 500 for conducting a remote assessment of a marijuana dispensary facility from the perspective of an assessor user, according to an embodiment. As shown, the method 500 begins in block 502, in which the platform application 104 receives login credentials from the assessor user. The login credentials may be transmitted by the assessor device 112 via a web-based user interface (e.g., displayed on the web browser application 114). The login credentials may include a username and password registered on the platform server 102.

In block 504, the platform application 104 receives a request for an assessment report associated with a given operator user. The request may include an identifier associated with the operator used to retrieve the report. In block 506, the platform application 104 determines whether the report is stored on the platform server 102. To do so, the platform application 104 may query the storage using the identifier provided in the request. If not, then the method 500 returns back to block 504. Otherwise, in block 508, the platform application 104 retrieves, from a storage location, the assessment report associated with the underlying operator of the dispensary facility.

In block 510, the platform application 104 presents the assessment report to the assessor user via the user interface. The assessor may use the assessment report, at least in part, to determine whether to approve or reject the report, and/or sustain or suspend the licensing for the operator's dispensary facility. Once so determined, the assessor may provide an indication via the user interface provided by the platform application 104 of whether to approve or reject the report, and/or sustain or suspend the facility's license. In block 512, the platform application 104 receives the indication from the assessor device 112. In block 514, the platform application 104 assigns the indication to the assessment report. Once assigned, the operator user may subsequently retrieve the report to identify the nature of the report, including whether the assessor issued an approval or a rejection, or identified areas for remedial action.

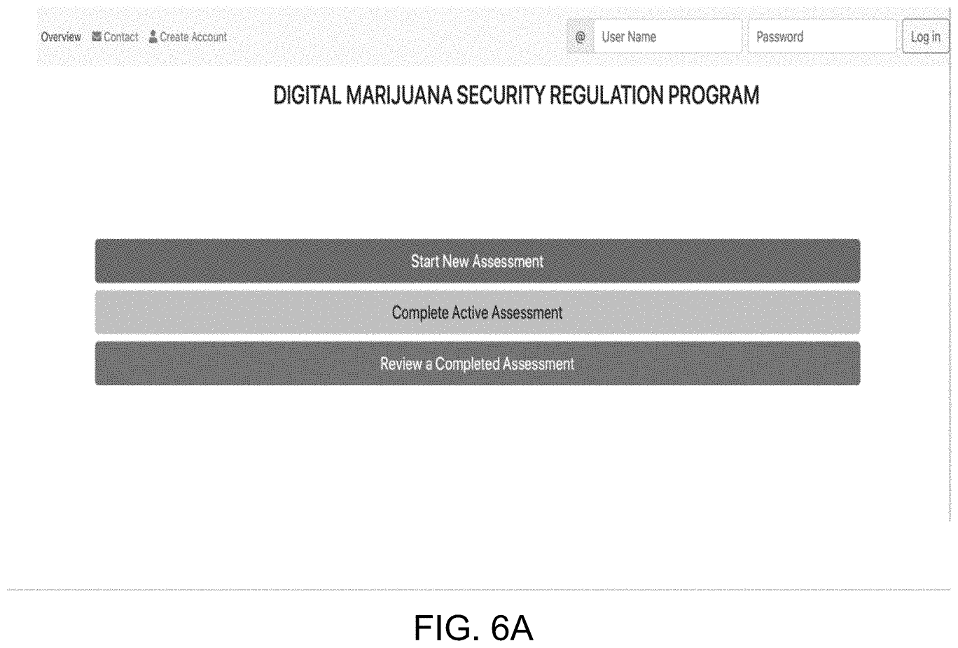

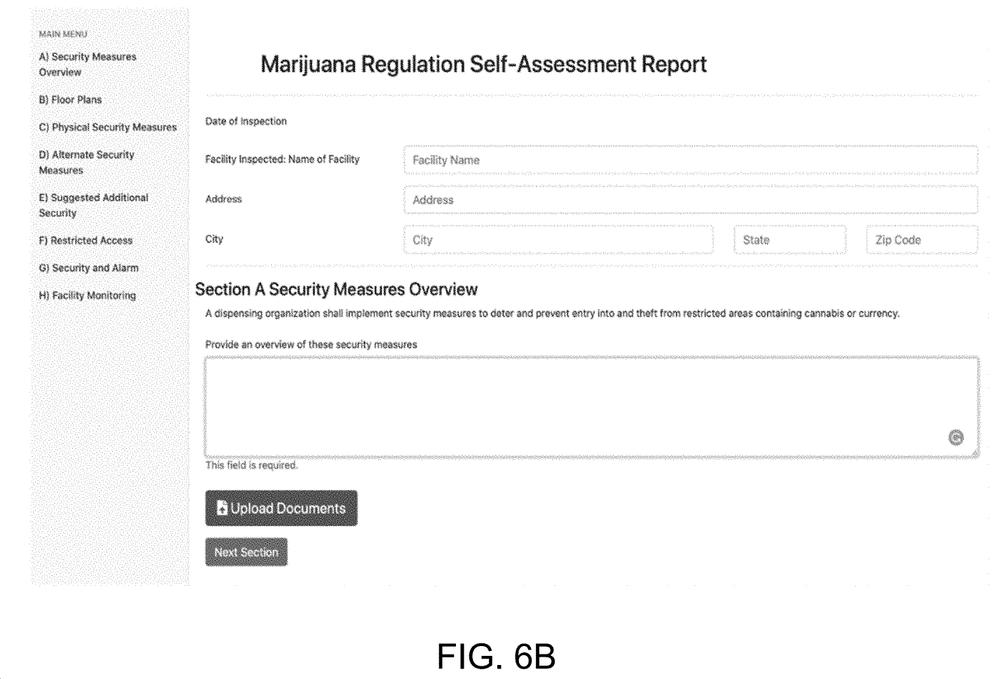

FIGS. 6A and 6B present exemplary views of a user interface. FIG. 6A presents a view of an initial page viewable by a user, such as the operator of the dispensary facility. As shown, the operator may select from several options, including “Start New Assessment,” “Complete Active Assessment,” and “Review a Completed Assessment.” The operator may select from one of these options to enter the respective workflow. FIG. 6B displays a view of a questionnaire prompt presented to the operator as part of the assessment. As shown toward the left-hand portion of the view, the questionnaire can include several sections, including security measures, floor plans, physical security measures, alternate security measures, additional security, restricted access, security and alarm, and facility monitoring. Each of these sections may correspond to underlying provisions of state regulations for marijuana dispensaries. The main portion of the view provides an exemplary prompt for the operator to “Provide an overview of these security measures.” The operator is prompted to provide a plain text description. Illustratively, the operator is also able to upload documents relevant to this prompt via a clickable “Upload Documents” button. On clicking the button, another display may appear on the screen to allow the operator to upload local (or remotely located) files to the platform.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration only, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media which may be read and executed by one or more processors. A machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided in sub-modules, sub-processes or other units of computer code or data as may be required by a particular design or implementation of the computing device.

In the drawings, specific arrangements or orderings of elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

1. A computer-implemented method for managing a remote assessment of a marijuana dispensary facility of an operator user, comprising:
generating, by execution of one or more processors and in response to a request to initiate an assessment of the marijuana dispensary facility of the operator user, a questionnaire prompt, wherein the questionnaire prompt maps regulations pertaining to marijuana dispensary authorization within a given state to a plurality of questions and requests for submissions;
presenting, via a user interface, the questionnaire prompt;
receiving, in response to the presentation of the questionnaire prompt, submission data from the operator user for the marijuana dispensary facility, the submission data including a combination of text responsive to the plurality of questions and multimedia data associated with the marijuana dispensary facility; and
generating, from the submission data, an assessment report for the marijuana dispensary facility.

2. The computer-implemented method of claim 1, further comprising:
receiving, from an assessor user, a request for the assessment report;
retrieving, in response to the request for the assessment report; the assessment report; and
presenting, via a second user interface, the assessment report to the assessor user.

3. The computer-implemented method of claim 2, further comprising:
receiving, from the assessor user, an indication of whether to approve or reject the assessment report; and
assigning the indication to the assessment report.

4. The computer-implemented method of claim 1, wherein the questionnaire prompt includes sections pertaining to at least one of security measures, floor plans, physical security measures, alternate security measures, restricted access, alarms, and monitoring associated with the marijuana dispensary facility.

5. The computer-implemented method of claim 1, wherein the multimedia includes photo and video data associated with the marijuana dispensary facility.

6. The computer-implemented method of claim 1, further comprising:
assigning an identifier associated with the operator user to the generated assessment report; and
storing the generated assessment report in a storage location.

7. The computer-implemented method of claim 1, wherein generating the questionnaire prompt comprises:
retrieving, from an external source, the regulations;
generating the questionnaire prompt from the retrieved regulations in combination with one or more rules using natural language processing techniques.

8. A non-transitory computer-readable storage medium storing instructions, which, when executed on one or more processors, causes a computing device to perform an operation for managing a remote assessment of a marijuana dispensary facility of an operator user, the operation comprising:
generating, in response to a request to initiate an assessment of the marijuana dispensary facility of the operator user, a questionnaire prompt, wherein the questionnaire prompt maps regulations pertaining to marijuana dispensary authorization within a given state to a plurality of questions and requests for submissions;
presenting, via a user interface, the questionnaire prompt;
receiving, in response to the presentation of the questionnaire prompt, submission data from the operator user for the marijuana dispensary facility, the submission data including a combination of text responsive to the plurality of questions and multimedia data associated with the marijuana dispensary facility; and
generating, from the submission data, an assessment report for the marijuana dispensary facility.

9. The non-transitory computer-readable storage medium of claim 8, wherein the operation further comprises:
receiving, from an assessor user, a request for the assessment report;
retrieving, in response to the request for the assessment report; the assessment report; and
presenting, via a second user interface, the assessment report to the assessor user.

10. The non-transitory computer-readable storage medium of claim 9, wherein the operation further comprises:
receiving, from the assessor user, an indication of whether to approve or reject the assessment report; and
assigning the indication to the assessment report.

11. The non-transitory computer-readable storage medium of claim 8, wherein the questionnaire prompt includes sections pertaining to at least one of security measures, floor plans, physical security measures, alternate security measures, restricted access, alarms, and monitoring associated with the marijuana dispensary facility.

12. The non-transitory computer-readable storage medium of claim 8, wherein the multimedia includes photo and video data associated with the marijuana dispensary facility.

13. The non-transitory computer-readable storage medium of claim 8, wherein the operation further comprises:
assigning an identifier associated with the operator user to the generated assessment report; and
storing the generated assessment report in a storage location.

14. The non-transitory computer-readable storage medium of claim 8, wherein generating the questionnaire prompt comprises:
retrieving, from an external source, the regulations;
generating the questionnaire prompt from the retrieved regulations in combination with one or more rules using natural language processing techniques.

15. A system, comprising:
one or more processors; and
a memory storing instructions, which, when executed on the one or more processors, causes the system to perform an operation for managing a remote assessment of a marijuana dispensary facility of an operator user, the operation comprising:
generating, in response to a request to initiate an assessment of the marijuana dispensary facility of the operator user, a questionnaire prompt, wherein the questionnaire prompt maps regulations pertaining to marijuana dispensary authorization within a given state to a plurality of questions and requests for submissions;
presenting, via a user interface, the questionnaire prompt;
receiving, in response to the presentation of the questionnaire prompt, submission data from the operator user for the marijuana dispensary facility, the submission data including a combination of text responsive to the plurality of questions and multimedia data associated with the marijuana dispensary facility; and
generating, from the submission data, an assessment report for the marijuana dispensary facility.

16. The system of claim 15, wherein the operation further comprises:
receiving, from an assessor user, a request for the assessment report;
retrieving, in response to the request for the assessment report; the assessment report; and
presenting, via a second user interface, the assessment report to the assessor user.

17. The system of claim 16, wherein the operation further comprises:
receiving, from the assessor user, an indication of whether to approve or reject the assessment report; and
assigning the indication to the assessment report.

18. The system of claim 15, wherein the questionnaire prompt includes sections pertaining to at least one of security measures, floor plans, physical security measures, alternate security measures, restricted access, alarms, and monitoring associated with the marijuana dispensary facility.

19. The system of claim 15, wherein the multimedia includes photo and video data associated with the marijuana dispensary facility.

20. The system of claim 15, wherein generating the questionnaire prompt comprises:
retrieving, from an external source, the regulations;
generating the questionnaire prompt from the retrieved regulations in combination with one or more rules using natural language processing techniques.
